(19) United States
(12) Patent Application Publication
(10) Pub. No.: US 2021/0120837 A1
(43) Pub. Date: Apr. 29, 2021

(54) COMPOSITE EDIBLE OIL AND THE MANUFACTURING METHOD THEREOF

(71) Applicant: Dien Liang Tony CHU, Hong Kong (CN)

(72) Inventor: Dien Liang Tony CHU, Hong Kong (CN)

(21) Appl. No.: 17/072,099

(22) Filed: Oct. 16, 2020

(30) Foreign Application Priority Data
Oct. 29, 2019 (HK) 19131606.6

(51) Int. Cl. A23D 9/04; A23D 9/007

(52) U.S. Cl. CPC A23D 9/04; A23D 9/007

(57) ABSTRACT

Disclosed is a composite edible oil and the manufacturing method thereof. The ingredients of the composite edible oil include peanuts, hempseeds, black sesame, pumpkinseeds, walnuts, linseeds, perilla seeds, and rosemary to maintain the freshness of the composite edible oil. The ratio of the monounsaturated fatty acid to the polyunsaturated fatty acid in the oil is around 1:1, and the ratio of ω-6 to ω-3 polyunsaturated fatty acid is around 4:1. Under the condition that the reference daily intake of composite edible oil should not exceed 20 ml-25 ml, the composite edible oil provides a scientific ratio among ω-3-ω-6 and ω-9 fatty acids for helping human bodies to reach nutritious equilibrium. By using UV degradation, the peroxide value, aflatoxin amount,and acid value contained in the composite edible oil meet the statutory requirements without the need of :fining process. Thus, the posite edible oil preserves beneficial substances, such as vitamin E.

### CROSS REFERENCE TO RELATED APPLICATION

The present application claims the priority of Hong Kong short-term Patent Application No. 19131606.6, filed on Oct. 29, 2019.

### FIELD OF THE INVENTION

The invention is related to an edible oil, and more particularly to a composite edible oil and the manufacturing method thereof.

### BACKGROUND OF THE INVENTION

The commercially available vegetable oil mostly comes from staple vegetable oil, whilst the sales of niche oil occupy only a small portion of the edible oil market. The staple vegetable oil contains an extremely low amount of ω-3 polyunsaturated fatty acid. Soybean oil, peanut oil, rapeseed oil, cottonseed oil, sunflower seed oil, and palm oil all belong to staple vegetable oil. Because human body cannot synthesize polyunsaturated fatty acid by itself, the only source to ingest polyunsaturated fatty acid is food. As a result, it is hard for the staple vegetable oil to meet the requirements on the acceptable daily intake of ω-3 polyunsaturated fatty acid.

In consideration of the commercial benefit, the commercially available vegetable oil is manufactured by the leaching method. The principle of the leaching method is to use an organic solvent that can solve lipids to spray and soak oils in the solvent to extract lipids from oils. The organic solvent used by the leaching method is a chemical, for example, No. 6 nonstandard solvent, acetone, and methylpentane. The oil manufactured by such method possesses an excessively high organic solvent residue and is detrimental to human health.

Most of the commercially available edible vegetable oils are refined oils. Virgin oil or leached crude oil is likely to possess moisture, gum soluble impurities, pigment, and may give off bad smell. Hence, oils must be processed with different refining processes. However, vitamin E which is beneficial to human body is removed along with impurities in the oils during the refining process. As a result, the refining process has the pros and cons.

More disadvantageously, the commercially available edible vegetable oil has a relatively high smoke point, which would badly affect human health.

When the edible oil is stored, its quality would change. The storage time and condition would significantly affect the quality of edible oil. Nowadays, the ability to preserve edible oil is somewhat poor. When the container of edible oil is opened and the edible oil is exposed to air, the anti-oxidative capability of the edible oil will deteriorate. Thus, the quality of edible oil cannot be assured.

In order to lower the manufacturing cost of edible oil, commercially available edible oil is packaged in plastic bottles or cans. Moreover, in order to prolong the storage time limit of the edible oil, anti-oxidative additives that are detrimental to human body are added to the edible oil.

### SUMMARY OF THE INVENTION

In view of the drawbacks encountered by the prior art, an object of the invention is to provide a composite edible oil for addressing the foregoing drawbacks.

To this end, the invention provides a composite edible oil, the technical details of the invention is as follows:

In accordance with a first aspect of the invention, the invention provides a composite edible oil, which is manufactured with the following ingredients: peanuts, black sesame, linseeds, hempseeds, pumpkinseeds, walnuts, perilla seeds, and rosemary.

The benefits of embodiments of the invention are: by selecting peanuts, black sesame, linseeds, hempseeds, pumpkinseeds, walnuts, perilla seeds, and rosemary as the materials, the composite edible oil is nutritious and has a strong aromatic smell, while preserving the original flavor of oil plant. More advantageously, embodiments of the invention avoid the adoption of materials with chemical residue and oils having a relatively high smoke point. Lastly, embodiments of the invention incorporate natural rosemary to allow the composite edible oil to have a good anti-oxidative capability for maintaining the freshness of composite edible oil.

In accordance with a second aspect of the invention, the invention provides a manufacturing method for a composite edible oil, which includes the following steps:

S1: using a hot expression method to express peanuts and black sesame in one shot to produce a peanut oil and a black sesame oil;

S2: processing the peanut oil and the black sesame oil with a deposition process, a filtration process, and an UV degradation process, respectively;

S3: using a cold expression method to express linseeds, hempseeds, pumpkinseeds, walnuts, and perilla seeds in one shot to produce a linseed oil, a hempseed oil, a pumpkinseed oil, a walnut oil, and a perilla seed oil;

S4: processing the linseed oil, the hempseed oil, the pumpkinseed oil, the walnut oil, and the perilla seed oil with a deposition process, a filtration process, and an UV degradation process, respectively;

S5: taking an appropriate portion of the processed peanut oil, the processed black sesame oil, the processed linseed oil, the processed hempseed oil, the processed pumpkinseed oil, the processed walnut oil, and the processed perilla seed oil by weight and blend the portions uniformly to produce a composite oil, in which a ratio of the monounsaturated fatty acid to the polyunsaturated fatty acid in the composite oil is greater than 0.9 but smaller than 1.1, and the ratio of ω-6 polyunsaturated fatty acid to ω-3 polyunsaturated fatty acid in the composite oil is greater than 2.8 but smaller than 5.2;

S6: adding dried rosemary into the composite oil and blend the composite oil and the dried rosemary uniformly to produce a composite edible oil; and

S7: filling a glass container with the composite edible oil to finish the manufacturing of the composite edible oil.

The manufacturing method is characterized in that the ratio of the monounsaturated fatty acid to polyunsaturated fatty acid is around 1:1, and the ratio of ω-6 polyunsaturated fatty acid to ω-3 polyunsaturated fatty acid is around 4:1. Under the condition that the reference daily intake of the composite edible oil should not exceed 20 ml-25 ml, the inventive composite edible oil provides a scientific ratio among ω-3, ω-6 and ω-9 fatty acids for helping human bodies to reach nutritious equilibrium. The composite edible oil is useful in preventing and relieving hypertension, diabetes, fatty liver disease, and tumor. By using UV degradation, the peroxide value, aflatoxin amount, and acid value contained in the composite edible oil can meet the statutory requirements on edible oil. Also, by using the glass container to contain the composite edible oil, the inventive composite edible oil is beneficial to human health. Moreover, because the method eliminates the refining process, the inventive composite edible oil preserves a considerable amount of beneficial substances, such as vitamin E.

Optionally, the portion for each oil at the step S5 is arranged 5 portions of peanut oil, 2 portions of black sesame oil, 0.5 portion of linseed oil, 0.5 portion of hempseed oil, 0.5 portion of pumpkinseed oil, 0.5 portion of walnut oil, and 1 portion of perilla seed oil. The portion of the dried rosemary at the step S6 is arranged by adding 0.4 gram of dried rosemary for each 250 ml of the composite oil.

Optionally, the temperature for expressing the peanuts and the black sesame is set to be above 80° C., and the temperature for expressing the linseeds, the hempseeds, the pumpkinseeds, the walnuts, and the perilla seeds is set to be below 80° C.

The manufacturing method is characterized in that the hot expression method is used to express materials that are suitable for hot expression for aromatizing the oil and improving the oil yield and quality, and the cold expression method is used to express other materials that are suitable for cold expression for preserving the nutrition of oil to the maximum extent.

Optionally, at the step S1, the peanuts and black sesame are first sautéed under an ambient temperature of 200° C. for 25-30 minutes.

In an embodiment, the invention is characterized in that the peanuts and black sesame are sautéed under an ambient temperature of 200° C. for 25-30 minutes for aromatizing the oil and promoting the oil yield and quality.

To render the object, characteristics, and advantages of the invention comprehensible, an exemplary embodiment of the invention will be given below to elaborate the invention.

### DETAILED DESCRIPTION OF PREFERRED EMBODIMENTS

To clearly illustrate the technological scheme of the invention, the following exemplary embodiment will be explained thoroughly. Apparently, the following exemplary embodiment is an example for putting the invention in practice, without the intention to exhaustively cover all possible embodiments.

Furthermore, the detailed description of the embodiment is given to elaborate the spirit and principle of the invention, without the intention to delineate the scope of the invention. Other embodiments of the invention derived by an artisan skilled in the art are still within the scope of the invention.

This embodiment provides a composite edible oil including the following ingredients: peanuts, black sesame, linseeds, hempseeds, pumpkinseeds, walnuts, perilla seeds, and rosemary. In this embodiment, peanut, hempseed, black sesame, pumpkinseed, walnut, linseed, and perilla seed are selected as the materials to manufacture the composite edible oil with the expression method.

Next, the characteristics of the materials selected by this embodiment are described below:

Peanut: Peanuts contain oleic acid, Linoleic acid, saturated fatty acid, accompaniments of fats, vitamins, and assorted minerals. Peanuts are useful in lowering the cholesterol in blood plasma, preventing arteriosclerosis and coronary heart disease, enforcing memory, ameliorating dermatosis, prolonging life, and protecting cardiovascular and cerebral blood vessels.

Black sesame: Black sesame contains monounsaturated fatty acid, polyunsaturated fatty acid, saturated fatty acid, sesamin, vitamins, and assorted minerals. Further, black sesame also contains amino acids that are essentials to human bodies, irons, and vitamin E Black sesame is useful in prolonging life, nourishing hairs, preventing hair loss, tonifying spleen and replenishing qi, relaxing bowels to relieve constipation, preventing or relieving hypertension, and benefiting postpartum breastfeeding and maintaining skin elasticity.

Linseed: Linseeds contain a-linolenic acid, oleic acid, linolenic acid, saturated fatty acid, and accompaniments of fats. Linseeds mainly consist of sticky substances and vitamin E. Linseeds are useful in optimizing the fat content of skin, ameliorating skin problems, relieving feminine synthetic symptoms, stabilizing mood, keeping calmness, reducing depression and insomnia, reducing allergic reactions, curing and preventing arthritis, preventing the inflammation of organic tissues, lowering hypertension, and lowering fat content in blood.

Walnut: Walnuts contain oleic acid, linolenic acid, a-linolenic acid, saturated fatty acid, and accompaniments of fats. Walnuts also contain vitamin A, vitamin E, and aromatic molecules. Walnuts are useful in maintaining the elasticity and moisture of skin, suppressing facial wrinkles, preventing aging, protecting hairs, nourishing and strengthening brain, preventing cardiovascular diseases, accelerating die development of bones, and maintaining bone density.

Pumpkinseed: Pumpkinseeds contain oleic acid, linolenic acid, and saturated fatty acid. Pumpkinseeds mainly consist of vitamin E, phytosterol, and chlorophyll. Pumpkinseeds are useful in reducing early swelling of the prostate and curing and preventing urological system and prostate hyperplasia. Pumpkinseeds are also useful in lowering cholesterol and blood sugar, preventing and caring cerebral and cardiovascular diseases and diabetes, and preventing arteriosclerosis. Pumpkinseeds are useful in preventing pertussis, postpartum hypogalactia, internal hemorrhoids, anemia, swollen hands and feet after delivery.

Perilla seed: Perilla seeds contain palmitic acid, stearic acid, oleic acid, linoleic acid, and a-linolenic acid. Perilla seeds are useful in clearing cholesterol, preventing thrombus, promoting the growth of synapses between cerebral neurons, enhancing memory, delaying aging, restraining breast cancer and colon cancer, promoting the growth of cerebral neurons, controlling high blood pressure and high blood lipids, and preventing atherosclerosis.

Hempseed: Hempseeds contain protein, fat, and carbohydrate. Hempseed is also rich in a-linolenic acid. Further, hempseeds mainly consist of monounsaturated fatty acid and polyunsaturated fatty acid with their content being 80% or above. Hempseeds are useful in lowering blood lipids and cholesterol, preventing and curing cerebral and cardiovascular disease, antagonizing aging, clearing free radicals, relaxing bowels to relieve constipation, and moisturizing dryness and ridding of insects.

The manufacturing method of the edible oil according to this embodiment includes the following steps:

S1. using a hot expression method to respectively express peanuts and black sesame in one shot to produce peanut oil and black sesame oil;

S2. processing the peanut oil and black sesame oil with deposition, filtration, and UV degradation process, respectively;

S3: using a cold expression method to respectively express linseeds, hempseeds, pumpkinseeds, walnuts, and perilla seeds in one shot to produce linseed oil, hempseed oil, pumpkinseed oil, walnut oil, and perilla seed oil;

S4: processing the linseed oil, hempseed oil, pumpkinseed oil, walnut oil, and perilla seed oil with deposition, filtration, and UV degradation process, respectively;

S5: taking 5 portions of processed peanut oil, 2 portions of processed black sesame oil, 0.5 portions of processed linseed oil, 0.5 portion of processed hempseed oil, 0.5 portion of processed pumpkinseed oil, 0.5 portion of processed walnut oil, and 1 portion of processed perilla seed, in which the portion is measured by weight, and blend the portions uniformly to produce a composite oil;

S6: adding dried rosemary into the composite oil by the ratio of adding 0.4 gram of dried rosemary for each 250 ml of composite oil and blend them uniformly to produce a composite edible oil;

S7: filling a glass container with the composite edible oil to finish the manufacturing of the composite edible oil.

In this embodiment, the peanut oil, black sesame oil, linseed oil, hempseed oil, pumpkinseed oil, walnut oil, and perilla seed oil do not require to undergo the refining process and do not require to be processed with the high-temperature degumming process, deacidification process, decolorization process, deodorizing process, and dewaxing process. Thus, the inherent nutrients in the oils can be maintained to the maximum extent. Also, because the problems of organic solvent residue are eliminated, the inventive composite edible oil is advantageous over the conventional vegetable oil prepared by the leaching method in terms of nutrition. Those oils contained in the inventive composite edible oil have a strong aroma and preserves the original flavor of the oil plant.

The weight percentage (wt %) of unsaturated fatty acid contained in peanut oil, black sesame oil, linseed oil, walnut oil, pumpkinseed oil, perilla seed oil, and hempseed oil is known in the art, as shown in the Table. 1 below.

TABLE 1

| Edible Oil | ω-3 | ω-6 | ω-9 |
|---|---|---|---|
| Peanut Oil | 0.05%~0.3% | 13.0%~43.0% | 35.0%~67.0% |
| Black Sesame Oil | 0.2%~1.0% | 36.9%~47.9% | 34.4%~45.5% |
| Linseed oil | 39.0%~62.0% | 12.0%~30.0% | 13.0%~39.0% |
| Walnut Oil | 6.5%~18.0% | 50.0%~69.0% | 11.5%~25.0% |
| Pumpkinseed Oil | — | 36.0%~61.0% | 21.0%~47.0% |
| Perilla Seed Oil | 44.0%~64.0% | 14.0%~17.0% | 13.0%~15.0% |
| Hempseed oil | 15.0%~23.0% | 30.2%~46.0% | 14.9%~22.0% |

In this embodiment, the content of ω-3 polyunsaturated fatty acid, ω-6 polyunsaturated fatty acid, and w-9 monounsaturated fatty acid in peanut oil, black sesame oil, linseed oil, walnut oil, pumpkinseed oil, perilla seed oil, and hempseed oil that are produced by this embodiment, is calculated by respectively multiplying the weight percentage shown in Table. 1 by the number of portions of the peanut oil, black sesame oil, linseed oil, walnut oil, pumpkinseed oil, perilla seed oil, and hempseed oil. The result is shown in Table. 2 (which is based on median of the weight percentage of the unsaturated fatty acid in each oil), Table. 3 (which is based on maximum of the weight percentage of the unsaturated fatty acid in each oil), and Table. 4 (which is based on minimum of the weight percentage of the unsaturated fatty acid in each oil) below.

TABLE 2

| | | Portion | | | Portion | | | Portion | |
|---|---|---|---|---|---|---|---|---|---|
| | | of | | | of | | | of | |
| Edible | Median | Oil (by | | Median | Oil (by | | Median | Oil (by | |
| Oil | of ω-3 | weight) | Sub-total | of ω-6 | weight) | Sub-total | of ω-9 | weight) | Sub-total |
| Peanut | 0.175 | 5 | 0.875 | 28 | 5 | 140 | 51 | 5 | 255 |
| Oil | | | | | | | | | |
| Black | 0.6 | 2 | 1.2 | 42.4 | 2 | 84.8 | 39.95 | 2 | 79.9 |
| Sesame | | | | | | | | | |
| Oil | | | | | | | | | |
| Linseed | 50.5 | 0.5 | 25.25 | 21 | 0.5 | 10.5 | 26 | 0.5 | 13 |
| oil | | | | | | | | | |
| Walnut | 12.25 | 0.5 | 6.125 | 59.5 | 0.5 | 29.75 | 18.25 | 0.5 | 9.125 |
| Oil | | | | | | | | | |
| Pumpkin- | — | 0.5 | 0 | 48.5 | 0.5 | 24.25 | 34 | 0.5 | 17 |
| seed Oil | | | | | | | | | |
| Perilla | 54 | 1 | 54 | 15.5 | 1 | 15.5 | 14 | 1 | 14 |
| Seed Oil | | | | | | | | | |
| Hempseed | 19 | 0.5 | 9.5 | 38.1 | 0.5 | 19.05 | 18.45 | 0.5 | 9.225 |
| oil | | | | | | | | | |
| Total | — | 10 | 96.95 | — | 10 | 323.85 | — | 10 | 397.25 |

| | |
|---|---|
| Total of the polyunsaturated fatty acids ω-6, ω-3 | 420.8 |
| The ratio of monounsaturated fatty acid ω-9 to | 0.9440351 |
| polyunsaturated fatty acids ω-6, ω-3 | 71:1 |
| The ratio of polyunsaturated fatty acid ω-6 to | 3.3403816 |
| polyunsaturated fatty acid ω-3 | 40:1 |

It can be seen from Table. 2 that as we take the median of the weight percentage of the unsaturated fatty acid in each oil, the ratio of the monounsaturated fatty acid to the polyunsaturated fatty acid in the composite edible oil according to this embodiment is 0.944035171:1, which is greater than 0.9 but smaller than 1.1, and is around 1:1. The ratio of the ω-6 polyunsaturated fatty acid to ω-3 polyunsaturated fatty acid is 3.340381640:1, which is greater than 2.8 and is smaller than 5.2, and is around 4:1. This ratio can adequately fulfill the demand on the human nutriology.

TABLE 3

| | | Portion | | Maxi- | Portion | | Maxi- | Portion | |
|---|---|---|---|---|---|---|---|---|---|
| | Maxi- | of | | mum | of | | mum | of | |
| Edible | mum | Oil (by | | of | Oil (by | | of | Oil (by | |
| Oil | of ω-3 | weight) | Sub-total | ω-6 | weight) | Sub-total | ω-9 | weight) | Sub-total |
| Peanut | 0.3 | 5 | 1.5 | 43 | 5 | 215 | 67 | 5 | 335 |
| Oil | | | | | | | | | |
| Black | 1 | 2 | 2 | 47.9 | 2 | 95.8 | 45.5 | 2 | 91 |
| Sesame Oil | | | | | | | | | |
| Linseed oil | 62 | 0.5 | 31 | 30 | 0.5 | 15 | 39 | 0.5 | 19.5 |
| Walnut | 18 | 0.5 | 9 | 69 | 0.5 | 34.5 | 25 | 0.5 | 12.5 |
| Oil | | | | | | | | | |
| Pumpkin- | — | 0.5 | 0 | 61 | 0.5 | 30.5 | 47 | 0.5 | 23.5 |
| seed Oil | | | | | | | | | |
| Perilla | 64 | 1 | 64 | 17 | 1 | 17 | 15 | 1 | 15 |
| Seed Oil | | | | | | | | | |
| Hempseed | 23 | 0.5 | 11.5 | 46 | 0.5 | 23 | 22 | 0.5 | 11 |
| oil | | | | | | | | | |
| Total | — | 10 | 119 | — | 10 | 430.8 | — | 10 | 507.5 |

| | |
|---|---|
| Total of the polyunsaturated fatty acids ω-6, ω-3 | 549.8 |
| The ratio of monounsaturated fatty acid ω-9 to | 0.9230629 |
| polyunsaturated fatty acids ω-6, ω-3 | 31:1 |
| The ratio of polyunsaturated fatty acid ω-6 to | 3.6201680 |
| polyunsaturated fatty acid ω-3 | 67:1 |

It can be seen from Table. 3 that as we take the maximum of the weight percentage of the unsaturated fatty acid in each oil, the ratio of the monounsaturated fatty acid to the polyunsaturated fatty acid in the composite edible oil according to this embodiment is 0.923062931:1, which is greater than 0.9 but smaller than 1.1, and is around 1:1. The ratio of the ω-6 polyunsaturated fatty acid to ω-3 polyunsaturated fatty acid is 3.620168067:1, which is greater than 2.8 and is smaller than 5.2, and is around 4:1. This ratio can adequately fulfill the demand on the human nutriology.

TABLE 4

| | | Portion | | | Portion | | | Portion | |
|---|---|---|---|---|---|---|---|---|---|
| | Mini- | of | | Mini- | of | | Mini- | of | |
| Edible | mum of | Oil (by | | mum | Oil (by | | mum | Oil (by | |
| Oil | ω-3 | weight) | Sub-total | of ω-6 | weight) | Sub-total | of ω-9 | weight) | Sub-total |
| Peanut | 0.05 | 5 | 0.25 | 13 | 5 | 65 | 35 | 5 | 175 |
| Oil | | | | | | | | | |
| Black | 0.2 | 2 | 0.4 | 36.9 | 2 | 73.8 | 34.4 | 2 | 68.8 |
| Sesame | | | | | | | | | |
| Oil | | | | | | | | | |
| Linseed | 39 | 0.5 | 19.5 | 12 | 0.5 | 6 | 13 | 0.5 | 6.5 |
| oil | | | | | | | | | |
| Walnut | 6.5 | 0.5 | 3.25 | 50 | 0.5 | 25 | 11.5 | 0.5 | 5.75 |
| Oil | | | | | | | | | |
| Pumpkin- | — | 0.5 | 0 | 36 | 0.5 | 18 | 21 | 0.5 | 10.5 |
| seed Oil | | | | | | | | | |
| Perilla | 44 | 1 | 44 | 14 | 1 | 14 | 13 | 1 | 13 |
| Seed Oil | | | | | | | | | |
| Hempseed | 15 | 0.5 | 7.5 | 30.2 | 0.5 | 15.1 | 14.9 | 0.5 | 7.45 |
| oil | | | | | | | | | |
| Total | — | 10 | 74.9 | — | 10 | 216.9 | — | 10 | 287 |

| | |
|---|---|
| Total of the polyunsaturated fatty acids ω-6, ω-3 | 291.8 |
| The ratio of monounsaturated fatty acid ω-9 to | 0.9835503 |
| polyunsaturated fatty acids ω-6, ω-3 | 77:1 |
| The ratio of polyunsaturated fatty acid ω-6 to | 2.8958611 |
| polyunsaturated fatty acid ω-3 | 48:1 |

It can be seen from Table. 4 that as we take the minimum of the weight percentage of the unsaturated fatty acid in each oil, the ratio of the monounsaturated fatty acid to the polyunsaturated fatty acid in the composite edible oil according to this embodiment is 0.983550377:1, which is greater than 0.9 but smaller than 1.1, and is around 1:1. The ratio of the ω-6 polyunsaturated fatty acid to ω-3 polyunsaturated fatty acid is 2.895861148:1, which is greater than 2.8 and is smaller than 5.2, and is around 4:1. This ratio can adequately fulfill the demand on the human nutriology.

In consideration of the fact that saturated fatty acid exists in various foods for daily diet and is able to be ingested naturally, the composite edible oil of this embodiment put great store in monounsaturated fatty acid and polyunsaturated fatty acid, but put little store in saturated fatty acid. If we intend to take the saturated fatty acid into account, we would ingest a surfeit of saturated fatty acid. This can manifest that the present method serves as a golden recipe based on scientific and medical knowledge.

In this embodiment, the selected oils of the composite edible oil are free of chemical residue. For example, walnut is the fruit of walnut tree and thus attracts little pest. Perilla has its own specific aroma with rare pest infestation, and thus it does not require agricultural chemicals.

In this embodiment, peanut oil, black sesame oil, linseed oil, hempseed oil, pumpkinseed oil, walnut oil, and perilla seed oil all have a low-to-medium smoke point, and their smoke points are 160° C., 177° C., 107° C., 90° C., 160° C., 160° C., 49° C., respectively. The inventive composite edible oil is suitable for use in stir-fry and cold sauce but is not naturally suitable for use in deep frying.

Generally, the aflatoxin contained in peanut oil and corn oil cannot exceed 20 μg/Kg. In this embodiment, the peroxide value, aflatoxin amount, acid value contained in the composite edible oil meet the statutory requirements by the UV degradation process applied to the peanut oil.

In this embodiment, the composite edible oil contains rosemary, which is a plant with high and effective anti-oxidation capability. Rosemary is useful in restraining oxidative effect on lipoidal substance of composite edible oil. Rosemary contains carnosic acid with high anti-oxidative property for activating beauty enzyme. Rosemary is also rich in polyphenols and fat-soluble substances, such as sage that can be solved in oil. In addition, carnosic acid can elevate the activity of the anti-oxidative enzyme (SOD) that is the so-called beauty enzyme, enhance fat metabolism, and restrain fat from being accumulated in the body.

In this embodiment, the inventor combines the theory and technical discretion of food technicians, nutritionists, and traditional Chinese medicine practitioners to survey and research the functions and healthiness of oils to make material selection and decide prescriptive proportions. Hence, the inventive composite edible oil can optimize the supply of nutrients for the human body under the condition that the reference daily intake of composite edible oil should not exceed 20-25 ml.

In conclusion, the exemplary embodiment discussed above is merely a preferred embodiment of the invention but is not used to limit the scope of the invention. For an artisan skilled in the art, the invention can encompass various modification and alterations that are made based on the spirit and principle of the invention without departing from the scope of the invention. The scope of the invention should be defined in the appending claims and their equivalents.

1. A composite edible oil, comprising a peanut oil, a black sesame oil, a linseed oil, a hempseed oil, a pumpkinseed oil, a walnut oil, a perilla seed oil, and rosemary.

2. The composite edible oil of claim 1, wherein the composite oil is manufactured by the steps of:
S1: using a hot expression method to express peanuts and black sesame in one shot to produce a peanut oil and a black sesame oil;
S2: processing the peanut oil and the black sesame oil with a deposition process, a filtration process, and an UV degradation process, respectively;
S3: using a cold expression method to express linseeds, hempseeds, pumpkinseeds, walnuts, and perilla seeds in one shot to produce a linseed oil, a hempseed oil, a pumpkinseed oil, a walnut oil, and a perilla seed oil;
S4: processing the linseed oil, the hempseed oil, the pumpkinseed oil, the walnut oil, and the perilla seed oil with a deposition process, a filtration process, and an UV degradation process, respectively;
S5: taking an appropriate portion of the processed peanut oil, the processed black sesame oil, the processed linseed oil, the processed hempseed oil, the processed pumpkinseed oil, the processed walnut oil, and the processed perilla seed oil by weight and blend the portions uniformly to produce a composite oil, in which a ratio of the monounsaturated fatty acid to the polyunsaturated fatty acid in the composite oil is greater than 0.9 but smaller than 1.1, and the ratio of ω-6 polyunsaturated fatty acid to ω-3 polyunsaturated fatty acid in the composite oil is greater than 2.8 but smaller than 5.2;
S6: adding dried rosemary into the composite oil and blend the composite oil and the dried rosemary uniformly to produce a composite edible oil; and
S7: filling a glass container with the composite edible oil to finish the manufacturing of the composite edible oil.

3. The composite edible oil of claim 2, wherein the portion for each oil at the step S5 is arranged as: 5 portions of peanut oil, 2 portions of black sesame oil, 0.5 portion of linseed oil, 0.5 portion of hempseed oil, 0.5 portion of pumpkinseed oil, 0.5 portion of walnut oil, and 1 portion of perilla seed oil, and wherein at the step S6, a portion of the dried rosemary is arranged by adding 0.4 gram of dried rosemary for each 250 ml of the composite oil.

4. The composite edible oil of claim 2, wherein a temperature for expressing the peanuts and the black sesame is set to be above 80° C., and a temperature for expressing the linseeds, the hempseeds, the pumpkinseeds, the walnuts, and the perilla seeds is set to be below 80° C.

5. The composite edible oil of claim 4, wherein at the step S1, the peanuts and the black sesame are first sautéed under an ambient temperature of 200° C. for 25-30 minutes.
